(19) United States
(12) Patent Application Publication
(10) Pub. No.: US 2026/0062518 A1
(43) Pub. Date: Mar. 5, 2026

(54) BODY TEMPERATURE LIQUID CRYSTALLINE ELASTOMER COMPOSITIONS AND METHODS OF MANUFACTURE AND USE

(71) Applicant: The Texas A&M University System, College Station, TX (US)

(72) Inventors: Taylor H. Ware, College Station, TX (US); Sasha George, College Station, TX (US); Seelay Tasmim, College Station, TX (US)

(21) Appl. No.: 19/311,631

(22) Filed: Aug. 27, 2025

Related U.S. Application Data
(60) Provisional application No. 63/687,392, filed on Aug. 27, 2024.

(51) Int. Cl. C08G 75/045; B29C 35/08; B29C 48/00; B29C 48/05; B29C 48/36; B29K 105/00; C08F 2/50

(52) U.S. Cl. CPC C08G 75/045; B29C 35/0805; B29C 48/022; B29C 48/05; B29C 48/36; C08F 2/50; B29C 2035/0827; B29C 2948/92704; B29K 2105/0002; B29K 2105/0079

(57) ABSTRACT

Provided herein are liquid crystalline elastomer (LCE) compositions capable of achieving high actuation strain in the narrow range of physiologically safe and relevant temperatures and methods of making the same. The methods disclosed herein leverage synthetic and processing approaches to achieve reversible shape change of LCE materials without the need for a bias load over the temperature range observed in contact with or inside the human body. The present methods utilize strategies to align the material polymer chains in their nematic state. By using processing conditions below a nematic-to-isotropic transition temperature (Tni) of the LCEs, the polymer chains can be suitably aligned and the resulting LCE can achieve reversible shape change over a physiologically relevant temperature range.

### REFERENCE TO RELATED APPLICATION

This application claims priority to and the benefit of U.S. Provisional Application No. 63/687,392, filed on Aug. 27, 2024, the disclosure of which is incorporated herein by reference in its entirety.

### GOVERNMENT SUPPORT

This invention was made with government support under grant number 2041671 awarded by U.S. National Science Foundation. The government has certain rights in the invention.

### TECHNICAL FIELD

The present disclosure generally relates to liquid crystalline elastomers compositions (LCEs) and methods for the manufacture and use of LCEs and, more specifically, includes systems and methods for the manufacture and use of LCEs capable of reversible shape change at physiologically relevant temperatures for biomedical applications.

### BACKGROUND

Liquid crystalline elastomers are rubbery materials that have the ability to achieve reversible shape change in response to stimuli, such as changes in temperature, light, and solvent. These materials can be programmed to change shapes by programming their molecular alignment. Their reversible shape-change properties, as well as their mechanical compliance, have rendered these materials excellent candidates for soft robotics and artificial muscles in the biomedical field. When considered as shape-changing materials, one of the main limitations of current LCE-based technologies is that the temperature required to achieve shape change is relatively high. This is especially the case when considering high actuation strain values. Most current LCE technologies that require low temperatures to change shape can only achieve very low strains when considering physiologically relevant temperatures.

### SUMMARY

To address the aforementioned issues, present embodiments involve synthetic and processing methods to yield LCE actuators capable of achieving high actuation strain in the narrow range of physiologically safe and relevant temperatures. The techniques disclosed herein can achieve LCEs that demonstrate significant shape change without bias loads. As such, these LCE materials can be used, for example, to design artificial muscles that can respond to changes in body temperature or ambient temperature without using a weight attached to the material.

The techniques disclosed herein leverage unique synthetic and processing approaches to maximize reversible shape change of LCE materials, without the need for a bias load, over the temperature range observed in contact with or inside the human body. The main challenge has been to synthesize and fabricate LCE actuators with a nematic-to-isotropic transition temperature (Tni) in the appropriate temperature range and achieve high strain at low temperatures. The present techniques utilize strategies to align the material polymer chains in their nematic state. Because the desired physiologically relevant temperature range for actuation of the LCE is from about 30 degrees Celsius (° C.) to about 42° C., the LCE should be processed at a temperature substantially lower than 30° C. By using processing conditions below room temperature, and more specifically below the Tni of the LCE, the polymer chains can be suitably aligned and the resulting LCE can achieve reversible shape change over a physiologically relevant temperature range. The cold processing temperatures enable the LCE to promptly cure to lock in the molecular alignment, which reduces or avoids any loss of alignment during curing and, in turn, ensures maximum strain. In some embodiments, mechanical stretching can be combined with other alignment processing techniques to further enhance the strain in the relevant temperature range. As such, by aligning the polymer chains at low temperature (in the nematic state) and by promptly crosslinking the polymer chains at the low temperature, and by optionally using mechanical stretching in combination with other alignment techniques to further enhance alignment of the polymer chains, LCEs can be fabricated that demonstrate a low Tni and high strain over a physiologically relevant temperature range. In some embodiments, uneven curing can be applied to either side of the LCE, causing one side to exhibit increased strain, resulting in bending upon heating. As such, in some embodiments, uneven curing can be utilized to further improve the contraction ratio around body temperature.

Embodiments include LCE compositions and methods for the manufacture and use of these liquid crystalline elastomers. One such embodiment includes a LCE having a plurality of polymer chains containing at least one diacrylate monomer oligomerized by a dithiol spacer and crosslinked by a vinyl crosslinker, in which the LCE has a nematic-to-isotropic transition temperature (Tni) of about 15 degrees Celsius (° C.). In some embodiments, the plurality of polymer chains of the LCE is configured to remain in a nematic state while the LCE is maintained at a temperature less than or equal to 30° C. In some embodiments, the plurality of polymer chains of the LCE is configured to reversibly transition to an isotropic state as the LCE is heated to temperatures greater than 30° C. and less than or equal to 45° C. In some embodiments, the LCE is configured to reversibly increase strain by about 20% as the LCE is heated from 35° C. to 45° C. In some embodiments, the LCE is configured to reversibly increase strain by about 2.3% per degree Celsius as the LCE is heated from 35° C. to 45° C. In some embodiments, the LCE is an LCE fiber configured to reversibly decrease in length by about 20% as the LCE fiber is heated from 35° C. to 45° C. In some embodiments, a weight ratio of the at least one diacrylate monomer to the vinyl crosslinker to the dithiol spacer within the plurality of polymer chains ranges from 0.5:0.5:1.0 to 0.9:0.1:1.0. In some embodiments, the at least one diacrylate monomer includes 1,4-bis-[4-(6-acryloyloxhexyloxy)benzoyloxy]-2-methylbenzene (RM82). In some embodiments, the at least one diacrylate monomer includes 1,4-bis[4-(3-acryloyloxypropyloxy) benzoyloxy]-2-methylbenzene (RM257). In some embodiments, the at least one diacrylate monomer includes both RM82 and RM257, and a weight ratio of RM82 to RM257 ranges from 30:70 to 70:30. In some embodiments, the at least one diacrylate monomer includes 45% RM82 and 55% RM257 by weight. In some embodiments, the dithiol spacer includes 2,2′-(ethylenedioxy)diethanethiol (EDDT). In some embodiments, the vinyl crosslinker includes triallyl-1,3,5-triazine-2,4,6-trione (TATATO).

One such method embodiment is a method of manufacturing a liquid crystalline elastomer that includes the step of combining at least one diacrylate monomer, a dithiol spacer, and a vinyl crosslinker to form a first mixture. The method includes the step of combining the first mixture with a base catalyst, a radical inhibitor, and a photoinitiator at an elevated temperature to form a LCE precursor mixture. The method includes the step of extruding the LCE precursor mixture onto a surface maintained at a temperature less than a nematic-to-isotropic transition temperature (Tni) of the LCE. The method includes the step of exposing the extruded LCE precursor mixture to ultraviolet (UV) light to crosslink the LCE precursor mixture, thereby to yield the LCE in a nematic state.

In some embodiments, a weight ratio of the at least one diacrylate monomer to the vinyl crosslinker to the dithiol spacer within the first mixture ranges from 0.5:0.5:1.0 to 0.9:0.1:1.0. In some embodiments, the at least one diacrylate monomer includes 1,4-bis-[4-(6-acryloyloxhexyloxy)benzoyloxy]-2-methylbenzene (RM82). In some embodiments, the at least one diacrylate monomer includes 1,4-bis[4-(3-acryloyloxypropyloxy) benzoyloxy]-2-methylbenzene (RM257). In some embodiments, the at least one diacrylate monomer includes both RM82 and RM257 and a weight ratio of RM82 to RM257 ranges from 30:70 to 70:30. In some embodiments, the at least one diacrylate monomer includes 45% RM82 and 55% RM257 by weight. In some embodiments, the dithiol spacer includes 2,2′-(ethylenedioxy)diethanethiol (EDDT). In some embodiments, the vinyl crosslinker includes triallyl-1,3,5-triazine-2,4,6-trione (TATATO). In some embodiments, the base catalyst includes triethylamine (TEA), the radical inhibitor includes butylated hydroxytoluene (BHT), and the photoinitiator includes Irgacure 369 (I-369). In some embodiments, the Tni of the LCE is about 15° C. In some embodiments, the temperature at which the surface is maintained during extruding ranges from about 4° C. to about 12° C. In some embodiments, at least a portion of the exposing of the extruded LCE precursor mixture to UV light is performed while the extruded LCE precursor mixture is maintained at the temperature less than the Tni of the LCE. In some embodiments, an intensity of the UV light ranges from 75 milliwatts per square centimeter (mW/cm²) to 200 mW/cm².

Aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a diagrammatic representation of a printed LCE fiber undergoing reversible shape changes upon heating and cooling over a physiologically relevant temperature range, such as from about 30° C. to about 42° C., according to an embodiment.

FIGS. 2A, 2B, and 2C are illustrations of the chemical structures of starting materials used to synthesize LCEs, according to an embodiment.

FIG. 3 is a diagrammatic representation of an embodiment of a method for manufacturing an LCE, according to an embodiment.

FIG. 4 is a graphical representation of the results of a differential scanning calorimetry (DSC) analysis of the LCE, according to an embodiment.

FIGS. 5A, 5B, 5C, 5D, 5E, and 5F are photographic representations of forward-looking infrared (FLIR) images collected for six LCE fibers after 15 minutes of UV light exposure after printing, according to an embodiment.

FIG. 6 is a graphical representation results of a strain study of LCE fibers, according to an embodiment.

FIGS. 7A, 7B, 7C, 7D, 7E, 7F, 7G, 7H, 7I, 7J, 7K, and 7L are photographic representations of an LCE fiber at various temperatures in the temperature range from 30° C. to 45° C. collected as part of a first length study, according to an embodiment.

FIGS. 8A, 8B, 8C, and 8D are photographic representations of an LCE fiber at various temperatures in the temperature range from 37° C. to 43° C. collected as part of a second length study, according to an embodiment.

### DETAILED DESCRIPTION

The present disclosure describes various embodiments related to LCE compositions and systems and methods for the manufacture and use of the same. Specific embodiments include LCEs capable of reversible shape change at physiologically relevant temperatures and systems and methods for the manufacture and use of the same. The description may use the phrases “in certain embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous. The term “plurality” as used herein refers to two or more items or components. The terms “about” or “approximately” are defined as being close to as understood by one of ordinary skill in the art. In one non-limiting embodiment, these terms are defined to be within 10%, preferably within 5%, more preferably within 1%, and most preferably within 0.5%.

The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The terms “wt. %”, “vol. %”, or “mol. %” refers to a weight, volume, or molar percentage of a component, respectively, based on the total weight, the total volume of material, or total moles, which includes the component. In a non-limiting example, 10 grams of component in 100 grams of the material is 10 wt. % of component. As used herein, the terms “extruding” and “printing”are used interchangeably.

The techniques disclosed herein leverage unique synthetic and processing approaches to maximize reversible shape change of LCE materials without the need for a bias load over the temperature range observed in contact with or inside the human body. A generally goal of the present approach is to achieve reversible changes in the length and strain of LCE materials within the range of biological temperatures that are observed for homoiotherms (warm-blooded animals, such as mammals or birds) under different conditions. For example, in an embodiment, a LCE material may be designed to be placed or worn on the skin of a human patient and may undergo a reversible shape change in response to a change in temperature as a result of the patient experiencing an increase in body temperature due to a fever. For such embodiments, the LCE material may function as a simple thermometer that can be visually monitored by a caregiver to quickly and easily determine whether the patient is experiencing a fever. For the embodiments disclosed herein, it is generally desirable for the maximum shape change response of the LCE material to occur within the physiological temperature range for homoiotherms, such as from about 30 degrees Celsius (° C.) to about 42° C. for human applications.

Prior to the present disclosure, fabrication of shape changing elements have mainly relied on the use of particular materials that enable shape change in response to stimuli. Many stimuli responsive materials, such as NiTiNOL and shape memory polymers, have already been used for use in biomedical applications. As such, it is envisioned that the disclosed LCEs can be used to develop biomedical devices that can achieve significant and untethered shape change in response to physiologically relevant temperatures.

For LCEs disclosed herein, the chemistry involved to achieve reversible shape change at lower temperatures targets a low nematic-to-isotropic transition temperature (Tni). Current methods to lower Tni include lowering the amount of the LC interactions in the polymer chains. This can be done by using long and flexible chain extenders, reducing the amount of overall LC molecules, or even using LC monomers with fewer aromatic rings to minimize the pi-pi interactions between these rings. Although researchers have been able to achieve LCEs with low Tni using these strategies, maximizing strain under low temperatures has remained a challenge.

The present techniques generally utilize novel strategies to align the material polymer chains of the LCE in their nematic state. Tuning the LCE phase transition is especially challenging at least in part because, after printing and crosslinking, the actual phase transition of the LCE is shifted relative to a predicted phase transition of the LCE. As such, for the embodiments disclosed herein, the chemistry and the processing of the LCE are leveraged to yield LCE actuators that demonstrate a maximum response over a physiologically relevant temperature range. To achieve maximum strain in physiologically relevant temperatures with good repeatability, the polymer chains are aligned at a temperature below the transition range, which falls below room temperature. Additionally, promptly curing and locking the alignment prevents loss of alignment and, in turn, ensures maximum strain. These features are novel and unique to the embodiments disclosed herein. For the embodiments discussed herein, the total amount of LC molecules in the polymer network are relatively low to achieve low Tni, and then processing (e.g., alignment and prompt crosslinking) is performed at reduced temperatures to maximize reversible strain.

In particular, because the desired physiologically relevant temperature range for actuation of the LCE is from about 30 degrees Celsius (° C.) to about 42° C., the LCE should be processed at a temperature substantially lower than 30° C. By using processing conditions below room temperature, and more specifically below the Tni of the LCE, the polymer chains can be suitably aligned, and the resulting LCE can achieve reversible shape change over a physiologically relevant temperature range. As discussed herein, this novel low-temperature processing involves, prior to crosslinking, extruding a LCE precursor mixture onto a surface that is cooled to a temperature below the Tni (e.g., 15° C.). While the disclosure focuses on the synthesis and processing of LCE fibers, the techniques disclosed herein may be applicable to other printing techniques, such as three-dimensional (3D) printing, for the manufacture of two-dimensional (2D) and/or 3D objects and patterns.

### Materials

Materials for experimental examples discussed herein include a first LC monomer, 1,4-bis-[4-(6-acryloyloxhexyloxy)benzoyloxy]-2-methylbenzene (referred to herein as “RM82”) purchased from Daken Chemical Limited. A second LC monomer, 1,4-bis[4-(3-acryloyloxypropyloxy) benzoyloxy]-2-methylbenzene (referred to herein as “RM257”) was purchased from Willshire Technologies, Inc. The LC monomers are also more generally referred to herein as “diacrylate monomers.” A thiol difunctional spacer, 2,2′-(ethylenedioxy)diethanethiol (also referred to herein as “EDDT”, the “thiol monomer”, or the “dithiol spacer”) was purchased from Sigma-Aldrich. A tetra-functional vinyl crosslinker, triallyl-1,3,5-triazine-2,4,6-trione, also referred to herein as “TATATO” or the “vinyl crosslinker”, was purchased form Sigma-Aldrich. A photoinitiator, Irgacure 369, referred to herein as “I-369”, was purchased from Sigma-Aldrich. A base-catalyst, triethylamine (TEA), and a radical inhibitor, butylated hydroxytoluene (BHT), were purchased from Sigma-Aldrich.

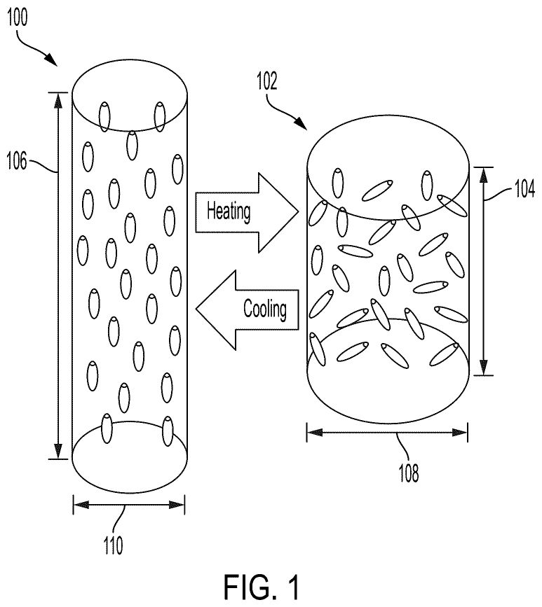

FIG. 1 is a diagrammatic representation of an embodiment of a printed LCE fiber 100 undergoing reversible shape changes upon heating and cooling over a physiological temperature range, such as from about 30° C. to about 42° C. For the illustrated embodiment, the as-printed LCE fiber 100 demonstrates the axial alignment of the polymer chains in the nematic state after printing and crosslinking. As the as-printed, nematic LCE fiber 100 is heated to temperatures above about 30° C. and less than about 45° C., it gradually transitions to an isotropic LCE fiber 102. In the isotropic LCE fiber 102, polymer chains are randomly aligned, resulting in a shape change. More specifically, a length 104 of the isotropic LCE fiber 102 is less than a length 106 of the as-printed, nematic LCE fiber 100, while a width 108 of the isotropic LCE fiber 102 is greater than a width 110 of the as-printed, nematic LCE fiber 100. Upon cooling to about 30° C., the isotropic LCE fiber 102 increases in length and decreases in width as it transitions back to the as-printed, nematic LCE fiber 100. As such, the disclosed LCEs enable a substantial, reversible shape change over a physiologically relevant temperature range.

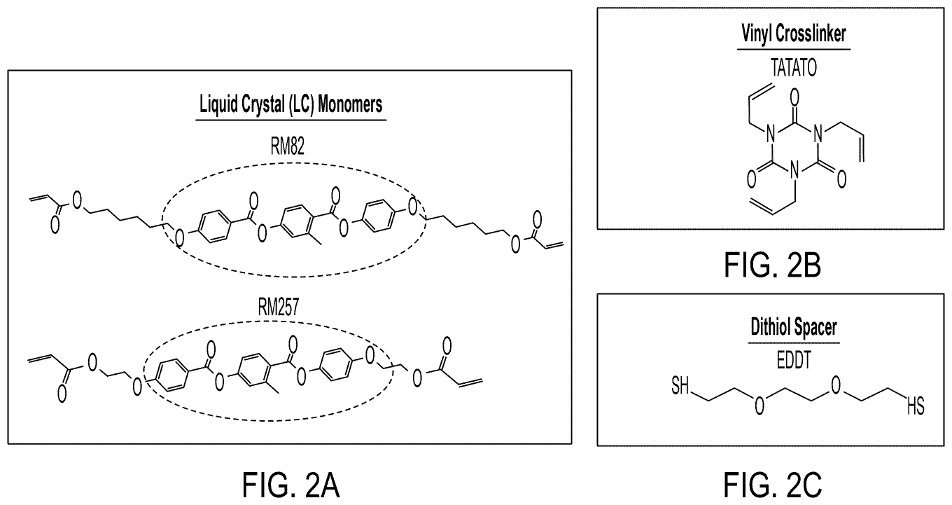

FIG. 2 is an illustration of the chemical structures of starting materials used to synthesize the LCEs for the embodiments discussed herein. More specifically, FIG. 2A illustrates the structures of RM82 and RM257 liquid crystalline (LC) monomers. FIG. 2B illustrates the structure of the vinyl crosslinker, TATATO. FIG. 2C illustrates the structure of the dithiol spacer, EDDT. The dashed ovals encircling the central, aromatic portions of the structures of the RM82 and RM257 monomers are included to explain mesogen or polymer chain alignment with respect to FIG. 1. In other words, the alignment of the central, aromatic portions of the polymerized RM82 and RM257 monomers define the overall alignment of the polymer chains, as shown in FIG. 1. The techniques described herein are not limited to these particular materials, and in some embodiments, LCE may be fabricated using similar or related monomers, crosslinkers, and/or spacers, in accordance with the techniques described herein.

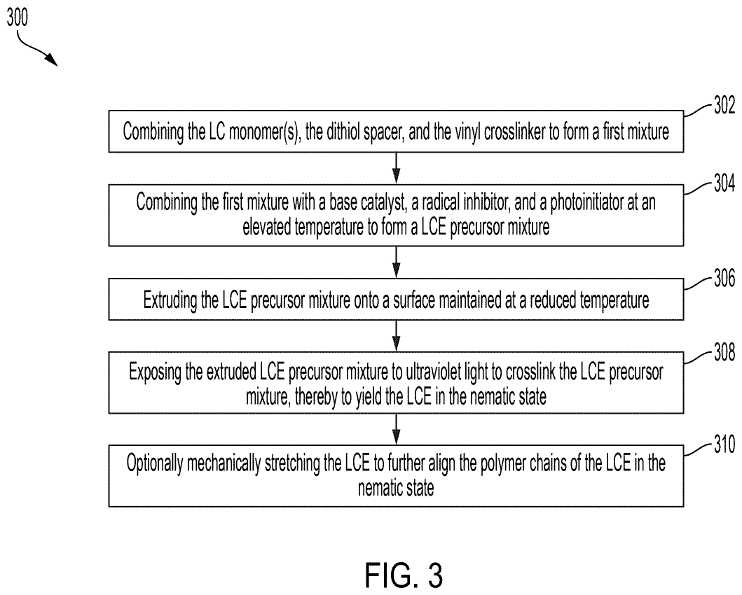

FIG. 3 is a diagrammatic representation of an embodiment of a method 300 for manufacturing an LCE. In some embodiments of the method 300, a thiol-acrylate Michael's addition reaction is first performed between the acrylate LC monomers and the dithiol spacer as part of a two-step reaction process for synthesizing the LCE. As such, the method 300 begins with the step 302 of combining the LC monomer(s) (RM257 and/or RM82), the dithiol spacer (EDDT), and the vinyl crosslinker (TATATO) to form a first mixture. In some embodiments, the LC monomer is either 100 wt. % RM82 or 100 wt. % RM257, while in other embodiments, the LC monomers are a mixture of the two monomers having a weight ratio of RM82 to RM257 ranging from 30:70 to 70:30, or from 40:60 to 80:20. In an example embodiment, the LC monomers include a mixture of 55 wt. % RM257 and 45 wt. % RM82. In some embodiments, a weight ratio of LC monomers to vinyl crosslinker to dithiol spacer in the first mixture ranges from 0.5:0.5:1.0 to 0.9:0.1:1.0, such as from 0.6:0.4:1.0 to 0.85:0.15:1.0, or from 0.7:0.3:1.0 to 0.8:0.2:1.0. To homogenously mix the ingredients, this mixture is heated to 70° C. and then vortexed for 1 minute, and this is repeated three times (3×) to ensure complete mixing.

For the embodiment illustrated in FIG. 3, the method 300 continues with the step 304 of combining the first mixture with a base catalyst (TEA), a radical inhibitor (BHT), and a photoinitiator (I-369) at an elevated temperature to form a LCE precursor mixture. In the example embodiment, 1 wt. % TEA, 2 wt. % BHT, and 1.5 wt. % I-369 was added to the first mixture. For the example embodiment, the resulting mixture was heated and homogeneously mixed before being transferred into a stainless-steel syringe to complete oligomerization in a 65° C. oven for 3 hours, thereby to yield the LCE precursor mixture, in which the LC monomer(s) are oligomerized by the dithiol spacer. This completes the first step of the two-step reaction.

For the embodiment illustrated in FIG. 3, the method 300 continues with the step 306 of extruding/printing the LCE precursor mixture onto a surface maintained at a reduced temperature. For the example embodiment, the LCE precursor mixture in the stainless-steel syringe is loaded onto a KR-2 print head Hyrel 3D (Norcross, GA). For the example embodiment, the syringe was then allowed to cool to room temperature overnight prior to extruding the LCE precursor mixture onto a rotating mandrel. For the example embodiment, the mandrel was made of polyethylene terephthalate from ULINE (Dallas, TX) with an outer diameter of 5.6 centimeters (cm) and was covered in a layer of Parafilm M sealing film (Burlington, MA). The mandrel contained encapsulated polycarbonate copolymer soaked in water, and was placed in a −2° C. freezer for a minimum of 12 hours prior to extrusion of the LCE precursor mixture. This allows the mandrel to maintain the extruded LCE precursor well-below the Tni of the LCE material (e.g., less than 15° C.), such as from 4° C. to 12° C., or from 7° C. to 10° C. The mandrel was subsequently removed from the freezer and placed on a custom step-up connected to a rotatory stepper motor powered by a direct current (DC) power source. During the extrusion process, the nozzle was only moving in the x direction (along the length of the mandrel) at a speed of 4.7 millimeters per second (mm/s) while the mandrel collected the LCE precursor mixture as a fiber. The mandrel speed could be varied by increasing or decreasing the voltage supply to the rotatory stepper motor. The mandrel speed could be varied from 5 revolutions per minute (RPM) to 15 RPM, such as from 6 RPM to 12 RPM, or from 7 RPM to 10 RPM. In some embodiments, the size of the needle used to extrude the LCE precursor mixture ranges from 10 gauge to 20 gauge, such as from 12 gauge and 18 gauge, or from 14 gauge to 16 gauge. For the example embodiment, nematic LCE fibers having diameters of 480 micrometers (μm) were achieved by adjusting the speed of mandrel rotation.

While a cylindrical mandrel was used to collect the extruded LCE precursor fibers for the example embodiment, in other embodiments, other printing surfaces may be used, such as a flat printing surface with three-dimensional positional control, similar to those used for 3D printing applications. Additionally, while the chilled, water-soaked polycarbonate copolymer was used to maintain the cool temperature of the printing surface during the extrusion and crosslinking process for the example embodiment, in other embodiments, other cooling systems may be used, such as vapor compression cooling systems, chiller systems, thermoelectric cooling systems, or another suitable cooling system. For some embodiments, in which the extruding process is performed in a higher humidity environment, a gas stream may be flowed over the printing surface during the extrusion and crosslinking steps to reduce humidity and/or remove condensation that forms as a result of the depressed temperature of the printing surface. For example, in some embodiments, the gas stream may be a fan-driven air stream, a dehumidified air stream, or an inert gas stream.

For the embodiment illustrated in FIG. 3, the method 300 continues with the step 308 of exposing the extruded LCE precursor mixture to ultraviolet (UV) light to crosslink the LCE precursor mixture, thereby to yield the LCE in the nematic state. This is a thiol-ene reaction between the thiols from the oligomer and the vinyl groups from the trifunctional vinyl crosslinker. As the fibers of the LCE precursor mixture are being extruded and collected on the cold mandrel surface, the fibers are simultaneously undergoing a photocrosslinking process to lock the alignment of the fibers. In some embodiments, the intensity of the UV light ranges from 75 milliwatts per square centimeter (mW/cm²) to 200 mW/cm², such as from 120 mW/cm² to 180 mW/cm², or from 150 mW/cm² to 180 mW/cm². For the example embodiment, while still being maintained at the lower temperature by the mandrel, the fibers produced in step 306 underwent a photocuring process to crosslink the aligned oligomers with 365 nanometer (nm) wavelength light at the intensity of 160 mW/cm² and the light was maintained for an additional 15 minutes. For the example embodiment, after printing and initial crosslinking, the LCE fibers were post-cured in a UV oven with an intensity of 3.4 mW/cm² for a time period ranging from 20 minutes to 40 minutes to ensure complete crosslinking of the material. The UV curing radical polymerization completes the second step of the two-step reaction process. For the embodiment illustrated in FIG. 3, the method 300 continues with the optional step 310 of mechanically stretching the LCE to further align the polymer chains of the LCE in the nematic state.

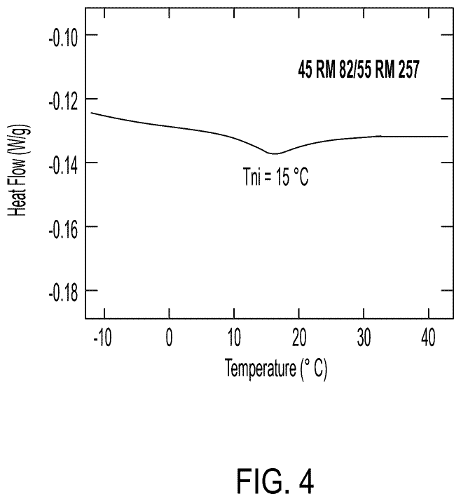

FIG. 4 is a graphical representation of the results of a differential scanning calorimetry (DSC) analysis of an embodiment of the LCE. For this analysis, the embodiment of the LCE was fabricated using a mixture of 45 wt. % RM82 and 55 wt. % RM257, prior to the addition of the dithiol spacer, the base catalyst, the radical inhibitor, and the photoinitiator. The DSC analysis was performed using a TA instruments Q800 (New Castle, DE, USA). The LCE inks were prepared with a sample mass of about 12 mg and loaded into the Tzero aluminum pans. The samples were first equilibrated at −40° C., and then heated to 100° C. at a rate of 10° C. per minute, and then cooled to −20° C. at a rate of 10° C. per minute, and the whole cycle is subsequently repeated. The Tni of the LCE was then determined using the endothermic well of the second heating cycle. As shown in FIG. 4, the endothermic well corresponded to a Tni of about 15° C. for the analyzed embodiment, which is desirable for an LCE having a maximum response within the relevant physiological temperature range.

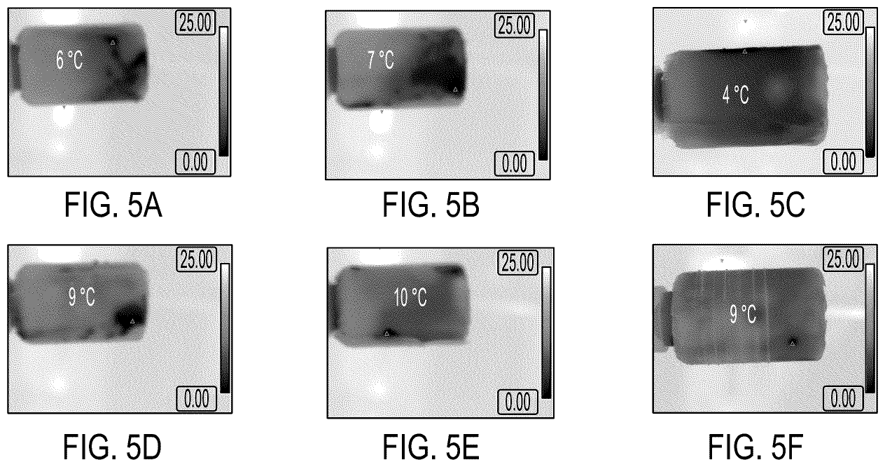

In an experimental study, the extruding and crosslinking steps (e.g., steps 306 and 308 of the method 300) of preparing the LCE were performed while the temperature of the mandrel printing surface was monitored using a thermal camera to evaluate the effectiveness of the cooling technique (i.e., chilled, water-soaked polycarbonate copolymer) used to maintain the temperature of the printing surface for the example embodiment. The thermal images were collected using a forward-looking infrared (FLIR) camera, namely a FLIR model A400 (Goleta, CA, USA). The temperature of the cold mandrel surface was measured after being placed on the motor setup (before printing), after the printing of the fibers is completed, and 15 minutes after printing (with UV light exposure), when the high intensity UV crosslinking has completed. This was repeated three times (3×) with different mandrels to ensure repeatability in maintaining cold surface temperatures. The images were then analyzed using FLIR analysis software, and an average temperature of the mandrel surface area was measured. FIGS. 5A-5F are photographic representations of FLIR images collected for six experiments 15 minutes after printing (with UV light exposure). As illustrated in FIGS. 5A-5F, for this example study, the temperature of the printing surface in these experiments was maintained at temperatures ranging from 4° C. to 10° C. throughout the extruding and crosslinking steps, which desirably resulted in the production of LCE fibers in the nematic state.

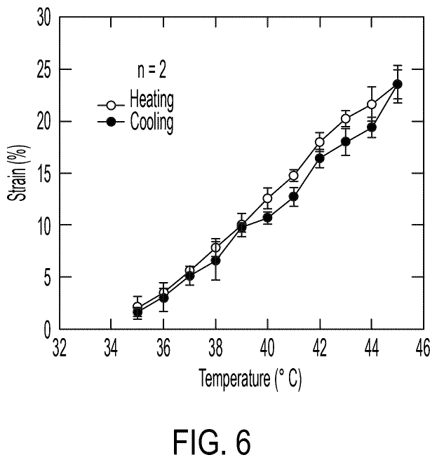

FIG. 6 is a graphical representation results of a strain study for an embodiment of the LCE fibers. More specifically, FIG. 6 is a graph illustrating average percent strain as a function of temperature for two LCE fiber samples. The graph includes a first curve that represents the increase in strain as the LCE fibers were heated from 35° C. to 45° C., while the second curve represents the decrease in strain as the LCEs were cooled from 45° C. to 35° C. As such, the results illustrated in FIG. 6 demonstrate a 20% change in strain over a 10° C. temperature window within a physiologically relevant temperature range. Accordingly, embodiments of the LCE fiber demonstrate strain deltas of about 2.3% per degree Celsius (/° C.), (±0.06%) in the temperature range from about 35° C. to about 45° C. during both heating and cooling cycles. Furthermore, in some embodiments, by the unevenly curing two sides of an LCE fiber, higher contraction ratios can be achieved within this physiologically relevant temperature regime.

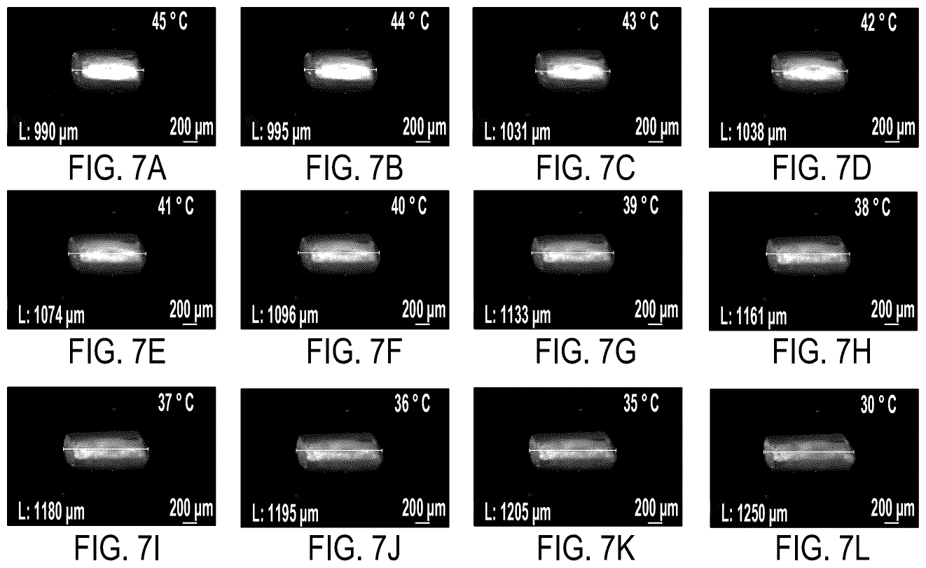

FIGS. 7A-7L are photographic representations of an embodiment of the LCE fiber at various temperatures in the temperature range from 30° C. to 45° C. collected as part of a first length study. The images were collected using a polarized optical microscope, and more specifically, a Nikon ECLIPSE LV100N POL (Melville, NY). To analyze the actuation behavior of the LCE fiber samples, a Linkam thermal stage (Redhill, UK) was used to control the temperature. Small pieces of the fiber were cut and placed on a glass slide with silicone oil to prevent adhesion. The LCE fiber sample was placed in the holder on the thermal stage, and length was measured at every degree Celsius for two heating and cooling cycles. The length changes from the second cooling cycle were used to calculate strain measurements presented in FIG. 6, as well as the length measurements presented in FIGS. 7A-7L. At 30° C., the measured length of the LCE fiber was about 1250 micrometers (μm), while at 45° C., the measured length of the LCE fiber was about 990 μm, representing about a 21% reversible change in length over the observed temperature range. For the temperature window presented in FIG. 6, at 35° C., the measured length of the LCE fiber was about 990 μm, and at 45° C., the measured length of the LCE fiber was about 1206 μm, representing about an 18% reversible change in length. As such, embodiments of the LCE fiber enable a substantial reversible shape change, as well as a substantial reversible change in strain, with minimal hysteresis over a physiologically relevant temperature range without a bias load.

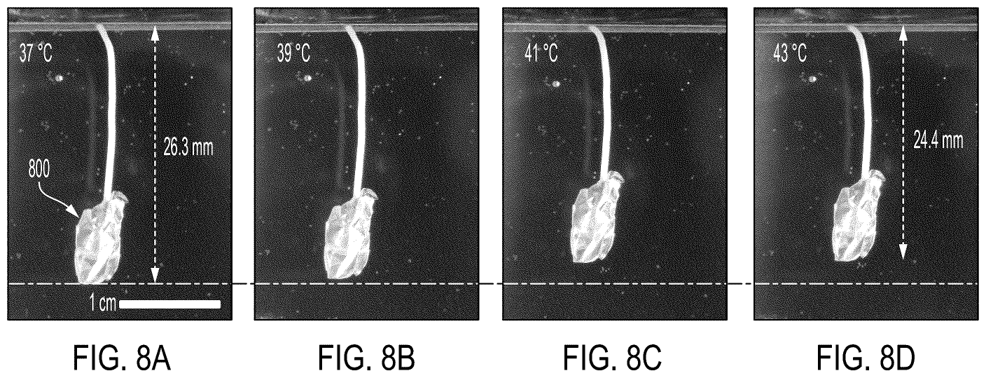

FIGS. 8A-8D are photographic representations of an embodiment of the LCE fiber at various temperatures in the temperature range from 37° C. to 43° C. collected as part of a second length study. For the second length study, a 31 milligram (mg) weight 800 was attached to the LCE fiber, and then the weight was then suspended by the LCE fiber into a water bath. As the water bath was heated between 37° C. (FIGS. 8A) and 43° C. (FIG. 8D), the length of the LCE fiber contracted from about 26.3 millimeters (mm) to about 24.4 mm, representing about a 7% reduction in length over the observed temperature window. As such, these results further indicate that embodiments of the LCE fiber enable a substantial reversible shape over a physiologically relevant temperature range.

Other objects, features, and advantages of the disclosure will become apparent from the foregoing figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from the detailed description. In further embodiments, features from specific embodiments may be combined with features from other embodiments. For example, features from one embodiment may be combined with features from any of the other embodiments. In further embodiments, additional features may be added to the specific embodiments described herein.

What is claimed is:

1. A liquid crystalline elastomer (LCE) comprising:
a plurality of polymer chains containing at least one diacrylate monomer oligomerized by a dithiol spacer and crosslinked by a vinyl crosslinker, the LCE having a nematic-to-isotropic transition temperature (Tni) of about 15 degrees Celsius (° C.).

2. The LCE of claim 1, wherein the plurality of polymer chains of the LCE is configured to remain in a nematic state while the LCE is maintained at a temperature less than or equal to 30° C.

3. The LCE of claim 2, wherein the plurality of polymer chains of the LCE is configured to reversibly transition to an isotropic state as the LCE is heated to temperatures greater than 30° C. and less than or equal to 45° C.

4. The LCE of claim 1, wherein the LCE is configured to reversibly increase strain by about 20% as the LCE is heated from 35° C. to 45° C.

5. The LCE of claim 1, wherein the LCE is configured to reversibly increase strain by about 2.3% per degree Celsius as the LCE is heated from 35° C. to 45° C.

6. The LCE of claim 1, wherein the LCE is an LCE fiber configured to reversibly decrease in length by about 20% as the LCE fiber is heated from 35° C. to 45° C.

7. The LCE of claim 1, wherein a weight ratio of the at least one diacrylate monomer to the vinyl crosslinker to the dithiol spacer within the plurality of polymer chains ranges from 0.5:0.5:1.0 to 0.9:0.1:1.0.

8. The LCE of claim 1, wherein the at least one diacrylate monomer comprises 1,4-bis-[4-(6-acryloyloxhexyloxy)benzoyloxy]-2-methylbenzene (RM82).

9. The LCE of claim 1, wherein the at least one diacrylate monomer comprises 1,4-bis[4-(3-acryloyloxypropyloxy) benzoyloxy]-2-methylbenzene (RM257).

10. The LCE of claim 1, wherein the at least one diacrylate monomer comprises both RM82 and RM257, and a weight ratio of RM82 to RM257 ranges from 30:70 to 70:30.

11. The LCE of claim 1, wherein the at least one diacrylate monomer comprises 45% RM82 and 55% RM257 by weight.

12. The LCE of claim 1, wherein the dithiol spacer comprises 2,2′-(ethylenedioxy)diethanethiol (EDDT).

13. The LCE of claim 1, wherein the vinyl crosslinker comprises triallyl-1,3,5-triazine-2,4,6-trione (TATATO).

14. A method of manufacturing a liquid crystalline elastomer (LCE) comprising:
combining at least one diacrylate monomer, a dithiol spacer, and a vinyl crosslinker to form a first mixture;
combining the first mixture with a base catalyst, a radical inhibitor, and a photoinitiator at an elevated temperature to form a LCE precursor mixture;
extruding the LCE precursor mixture onto a surface maintained at a temperature less than a nematic-to-isotropic transition temperature (Tni) of the LCE; and
exposing the extruded LCE precursor mixture to ultraviolet (UV) light to crosslink the LCE precursor mixture, thereby to yield the LCE in a nematic state.

15. The method of manufacturing of claim 14, wherein the at least one diacrylate monomer comprises 1,4-bis-[4-(6-acryloyloxhexyloxy)benzoyloxy]-2-methylbenzene (RM82).

16. The method of manufacturing of claim 14, wherein the at least one diacrylate monomer comprises 1,4-bis[4-(3-acryloyloxypropyloxy) benzoyloxy]-2-methylbenzene (RM257).

17. The method of manufacturing of claim 14, wherein the at least one diacrylate monomer comprises both RM82 and RM257 and a weight ratio of RM82 to RM257 ranges from 30:70 to 70:30.

18. The method of manufacturing of claim 14, wherein the dithiol spacer comprises 2,2′-(ethylenedioxy)diethanethiol (EDDT).

19. The method of manufacturing of claim 14, wherein the vinyl crosslinker comprises triallyl-1,3,5-triazine-2,4,6-trione (TATATO).

20. The method of manufacturing of claim 14, wherein at least a portion of the exposing of the extruded LCE precursor mixture to UV light is performed while the extruded LCE precursor mixture is maintained at the temperature less than the Tni of the LCE.
